(19) United States
(12) Patent Application Publication
(10) Pub. No.: US 2022/0334941 A1
(43) Pub. Date: Oct. 20, 2022

(54) PATTERN EXTRACTION AND RULE GENERATION APPARATUS, METHOD, AND PROGRAM

(71) Applicant: NIPPON TELEGRAPH AND TELEPHONE CORPORATION, Tokyo (JP)

(72) Inventors: Fumika ASAI, Musashino-shi, Tokyo (JP); Haruhisa NOZUE, Musashino-shi, Tokyo (JP); Shunsuke KANAI, Musashino-shi, Tokyo (JP); Satoshi SUZUKI, Musashino-shi, Tokyo (JP); Taisuke YAKAWA, Musashino-shi, Tokyo (JP); Naomi MURATA, Musashino-shi, Tokyo (JP)

(73) Assignee: NIPPON TELEGRAPH AND TELEPHONE CORPORATION, Tokyo (JP)

(21) Appl. No.: 17/634,798

(22) PCT Filed: Aug. 20, 2019
(86) PCT No.: PCT/JP2019/032503

§ 371 Date: Feb. 11, 2022

(51) Int. Cl. G06F 11/30; G06F 11/07

(52) U.S. Cl. CPC G06F 11/3082; G06F 11/0781

(57) ABSTRACT

A pattern extraction and rule generation device according to one embodiment includes a database where failure factor information including a failure factor location and a failure factor, an occurring failure event that is a failure event occurring due to a failure and a non-occurring failure event that is a failure event not occurring due to the failure, and a rule ID associated with a rule including condition parts and conclusion parts are registered, by a failure type, in association with each other, a unique determination unit that generates, by the failure type, all of one or more possible combinations of the occurring failure event and the non-occurring failure event included in a failure event group including the occurring failure event and the non-occurring failure event associated with a new failure, and extracts, from combinations of failure events of a new failure and combinations of failure events of one or more past failures, by the failure type, a unique pattern that is determined to be a combination most different from a failure event in other failure cases every time the new failure occurs, and a rule generation and modification unit that generates or modifies, when the non-occurring failure event is selected for the one or more possible combinations according to the unique pattern corresponding to each failure, the rule with the failure event as a negative condition.

### TECHNICAL FIELD

Embodiments of the present disclosure relate to a pattern extraction and rule generation device, method, and program.

### BACKGROUND ART

There is a technique related to creation of an IF-THEN rule that determines, on the basis of an event caused by a certain failure (hereinafter referred to as a failure event) in a monitoring target device, a failure factor that is a factor of occurrence of the failure.

For example, there is a technique in which a system receives an input of each of a condition part (IF part) that is a failure event to be defined in a rule by a maintenance person having knowledge about failures, and an event (THEN part) that is the cause (factor) of the failure, and the system creates a rule.

Further, in rule creation, there is a technique in which one failure event in the condition part of the rule is defined as a conclusion part.

Further, as disclosed in PTL 1, there is a technique that extract a combination of unique failure events for each failure case so as not to overlap with other failure cases registered in a failure case database, and, as a characteristic failure event, that automatically create and modify a rule by which a failure factor location can be determined.

### CITATION LIST

### Patent Literature

PTL 1: JP 2018-028778 A

### SUMMARY OF THE INVENTION

### Technical Problem

However, when there is a plurality of failure cases in which combinations of failure events are in an inclusion relationship, with a rule automatically created in the related art, there is a problem that it is not possible to distinguish that a combination of failure events in a certain failure case is included in a combination of failure events in another failure case and is not possible to make a rule, and such failure cases need to be isolated or manually ruled on the basis of the maintenance person's knowledge and experience about failure events.

The present disclosure has been made in view of the above situation, and an object of the present disclosure is to provide a pattern extraction and rule generation device, method, and program capable of appropriately generating a rule for determining a failure factor.

### Means for Solving the Problem

A pattern extraction and rule generation device according to an aspect of the present disclosure includes a database where failure factor information including a failure factor location and a failure factor, an occurring failure event that is a failure event occurring due to a failure and a non-occurring failure event that is a failure event not occurring due to the failure, and a rule ID associated with a rule including condition parts and conclusion parts are registered, by a failure type, in association with each other, a unique determination unit that generates, by the failure type, all of one or more possible combinations of the occurring failure event and the non-occurring failure event included in a failure event group including the occurring failure event and the non-occurring failure event associated with a new failure that is a newly occurring failure, and extracts, from combinations of failure events of a new failure and combinations of failure events of one or more past failures that are failures occurred in the past, by the failure type, a unique pattern that is determined to be a combination most different from a failure event in other failure cases every time the new failure occurs, and a rule generation and modification unit that generates or modifies, when the non-occurring failure event is selected for the one or more possible combinations according to the unique pattern corresponding to each failure, the rule with the failure event as a negative condition.

A pattern extraction and rule generation method according to an aspect of the present disclosure is a method performed by a unique pattern extraction and rule generation device including a database where failure factor information including a failure factor location and a failure factor, an occurring failure event that is a failure event occurring due to a failure and a non-occurring failure event that is a failure event not occurring due to the failure, and a rule ID associated with a rule including condition parts and conclusion parts are registered, by a failure type, in association with each other, the method including generating, by the failure type, all of one or more possible combinations of the occurring failure event and the non-occurring failure event included in a failure event group including the occurring failure event and the non-occurring failure event associated with a new failure that is a newly occurring failure, and extracting, from combinations of failure events of a new failure and combinations of failure events of one or more past failures that are failures occurred in the past, by the failure type, a unique pattern that is determined to be a combination most different from a failure event in other failure cases every time the new failure occurs, and generating or modifying, when the non-occurring failure event is selected for the one or more possible combinations according to the unique pattern corresponding to each failure, the rule with the failure event as a negative condition.

### Effects of the Invention

According to the present disclosure, a rule for determining a failure factor can be appropriately generated.

### BRIEF DESCRIPTION OF DRAWINGS

FIG. 1 is a diagram illustrating an example of a hardware configuration of a pattern extraction and rule generation device according to one embodiment of the present disclosure.

FIG. 2 is a diagram illustrating an example of a hardware configuration of a rule engine according to one embodiment of the present disclosure.

FIG. 3 is a block diagram illustrating an example of a software configuration of the pattern extraction and rule generation device according to one embodiment of the present disclosure.

FIG. 4 is a flowchart illustrating an example of processing operations of the pattern extraction and rule generation device illustrated in FIG. 3.

FIG. 5 is a block diagram illustrating an example of a software configuration of the pattern extraction and rule generation device and the rule engine illustrated in FIG. 3.

FIG. 6 is a diagram illustrating an example of classes in blocks illustrated in FIG. 5.

FIG. 7A is a flowchart illustrating an example of processing operations performed by the pattern extraction and rule generation device and the rule engine illustrated in FIG. 5.

FIG. 7B is a flowchart illustrating an example of processing operations performed by the pattern extraction and rule generation device and the rule engine illustrated in FIG. 5.

FIG. 7C is a flowchart illustrating an example of processing operations performed by the pattern extraction and rule generation device and the rule engine illustrated in FIG. 5.

FIG. 8A is a diagram describing an example of an IF-THEN rule.

FIG. 8B is a diagram describing an example of an IF-THEN rule.

FIG. 9 is a flowchart illustrating an example of a processing operation performed by a unique determination unit.

FIG. 10 is a diagram illustrating an example of a relationship between a failure case and a failure event corresponding to the failure case.

FIG. 11 is a diagram illustrating, in tabular form, an example of a relationship between a failure case and a failure event corresponding to the failure case.

FIG. 12 is a diagram illustrating, in tabular form, an example of a combination of failure events extracted from a candidate failure event group.

FIG. 13 is a diagram illustrating, in tabular form, an example of a combination of failure events extracted from a candidate failure event group.

FIG. 14 is a diagram illustrating, in tabular form, an example of a calculation result of similarity.

FIG. 15A is a diagram illustrating extraction of a unique pattern based on a degree of deviation.

FIG. 15B is a diagram illustrating extraction of a unique pattern based on the degree of deviation.

FIG. 16 is a diagram illustrating, in tabular form, an example of a calculation result of the degree of deviation.

FIG. 17 is a diagram illustrating, in tabular form, an example of a calculation result of the degree of deviation.

FIG. 18 is a diagram illustrating an example of a relationship between a failure case and a failure event corresponding to the failure case.

FIG. 19 is a diagram illustrating, in tabular form, an example of creation of a candidate failure event, the number of combination patterns, and a unique combination to be extracted.

### DESCRIPTION OF EMBODIMENTS

Hereinafter, one embodiment related to the present disclosure will be described in detail with reference to the drawings.

Configuration

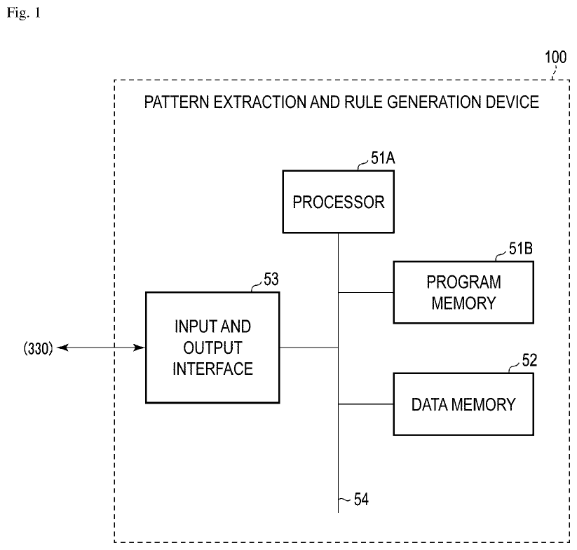

FIG. 1 is a block diagram illustrating an example of a hardware configuration of a pattern extraction and rule generation device 100 according to one embodiment of the present disclosure.

The pattern extraction and rule generation device 100 is constituted by, for example, a server computer or a personal computer, and has a hardware processor 51A such as a central processing unit (CPU). In the pattern extraction and rule generation device 100, a program memory 51B, a data memory 52, and an input and output interface 53 are connected to the hardware processor 51A via a bus 54.

The pattern extraction and rule generation device 100 is connectable to a rule engine 330, which will be described below.

The input and output interface 53 may include, for example, one or more wired or wireless communication interfaces. The input and output interface 53 inputs and outputs information from and to the rule engine 330.

The program memory 51B is such that, for example, a non-volatile memory that allows writing and reading at any time, such as a hard disk drive (HDD) or a solid state drive (SSD) and a non-volatile memory such as a ROM are used in combination as a non-transitory tangible computer-readable storage medium. A program necessary to execute various kinds of control processing according to one embodiment is stored in the program memory 51B.

The data memory 52 is such that, for example, the aforementioned non-volatile memory and a volatile memory such as a random access memory (RAM) are used in combination as a tangible computer-readable storage medium. This data memory 52 is used to store various data acquired and created in the process of performing various processing operations.

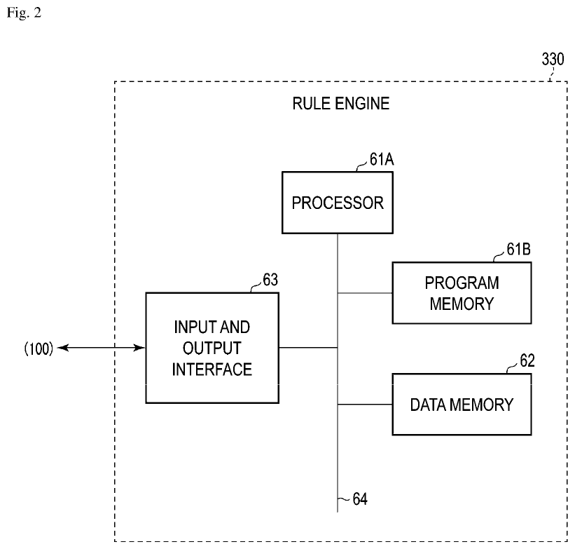

FIG. 2 is a block diagram illustrating an example of a hardware configuration of the rule engine 330 according to one embodiment of the present disclosure.

The rule engine 330 is constituted by, for example, a server computer or a personal computer and has a hardware processor 61A such as a CPU. In the rule engine 330, a program memory 61B, a data memory 62, and an input and output interface 63 are connected to the hardware processor 61A via a bus 64.

The rule engine 330 is connectable to the pattern extraction and rule generation device 100.

The input and output interface 63 may include, for example, one or more wired or wireless communication interfaces. The input and output interface 63 inputs and outputs information from and to the pattern extraction and rule generation device 100.

The program memory 61B is such that, for example, a non-volatile memory that allows writing and reading at any time, such as a hard disk drive (HDD) or a solid state drive (SSD) and a non-volatile memory such as a ROM are used in combination as a non-transitory tangible computer-readable storage medium. A program necessary to execute various kinds of control processing according to one embodiment is stored in the program memory 61B.

The data memory 62 is such that, for example, the aforementioned non-volatile memory and the aforementioned volatile memory such as a RAM are used in combination as a tangible computer-readable storage medium. This data memory 62 is used to store various data acquired and created in the process of performing various processing operations.

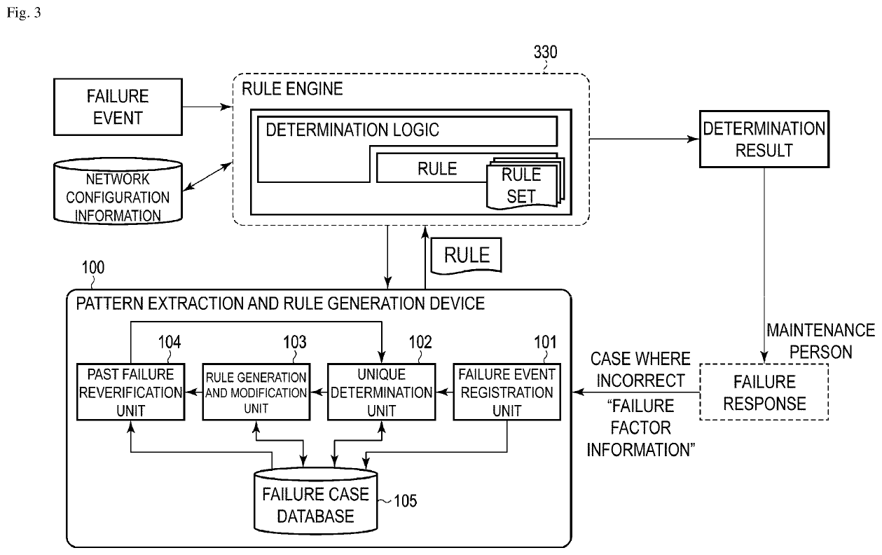

FIG. 3 is a block diagram illustrating an example of a software configuration of the pattern extraction and rule generation device according to one embodiment of the present disclosure. In FIG. 3, a software configuration of the pattern extraction and rule generation device 100 is illustrated in association with the hardware configuration illustrated in FIG. 1. As illustrated in FIG. 3, the pattern extraction and rule generation device 100 can be configured as a data processing device that includes a failure event registration unit 101, a unique determination unit 102, a rule generation and modification unit 103, a past failure reverification unit 104, and a failure case database 105 as processing function units by software.

The failure case database 105 in the pattern extraction and rule generation device 100 illustrated in FIG. 3 may be configured with the data memory 52 illustrated in FIG. 1. However, the failure case database 105 is not a necessary configuration in the pattern extraction and rule generation device 100, and may be provided in an external storage medium such as a universal serial bus (USB) memory or a storage device such as a database server arranged on a cloud.

All the above-described processing function units of the failure event registration unit 101, the unique determination unit 102, the rule generation and modification unit 103, and the past failure reverification unit 104 can be implemented by causing the aforementioned hardware processor 51A to read and execute the program stored in the program memory 51B. Note that some or all of the processing function units may be implemented by other various methods including an integrated circuit such as an application specific integrated circuit (ASIC) or a field-programmable gate array (FPGA).

The failure event registration unit 101 registers (1) one or more failure events (failure event group) corresponding to a newly occurred failure (also referred to as a present failure or a new failure) in the failure case database 105 in association with (2) failure ID of the present failure (sometimes referred to as a failure case ID), (3) failure factor information including a root cause and its location identified by a maintenance person, and (4) corresponding rule ID.

The failure ID is assigned to each failure occurred. The rule ID is assigned to each rule. The failure event is associated with a failure ID and indicates an event that is caused by a failure corresponding to the failure ID. This failure event is, for example, an alarm, log information, and threshold monitoring information from a certain monitoring target device. However, in the present embodiment, the failure event to be registered in association with the failure ID may include an occurring failure event that is a failure event occurring due to a failure, and a non-occurring failure event that is a failure event not occurring due to the failure.

The failure factor information includes information of a failure factor location and information of a failure factor.

This failure factor indicates the cause of occurrence of a failure, and the failure factor location indicates a location (for example, device ID) where a failure has occurred. The failure factor location is a certain monitoring target device.

Note that one or more failure events are also referred to as failure event groups. One or more rules are also referred to as a rule set.

For example, the rule engine 330 has the rule set, and a rule includes a condition part and a conclusion part.

In the present embodiment, the condition part is a failure event. The failure event may include, for example, a device ID and an alarm type. Further, in the present embodiment, the conclusion part is failure factor information. This failure factor information may include, for example, a device ID and a failure factor type.

The unique determination unit 102 generates, from the failure event group of the present failure registered in the failure case database 105, a combination of failure events including one or more failure events that are candidates for a unique pattern characterizing the present failure, and registers all combinations of the failure events of the present failure to the failure case database 105.

Along with this registration, the unique determination unit 102 refers to the combinations of failure events in all past failures registered in the failure case database 105.

The unique determination unit 102 extracts, from all of the referred combinations, a combination of failure events characterizing each failure as a unique pattern for each failure (that is, for each failure ID), and registers the result of this extraction in the failure case database 105 in association with the failure ID.

The combination of failure events exists for each failure ID, and is a combination of all failure events associated with the failure ID.

The unique pattern is calculated in a predetermined manner from a combination of failure events for each failure ID, and one unique pattern is calculated for each failure ID. Moreover, the unique pattern corresponds to the rule ID in a one-to-one manner.

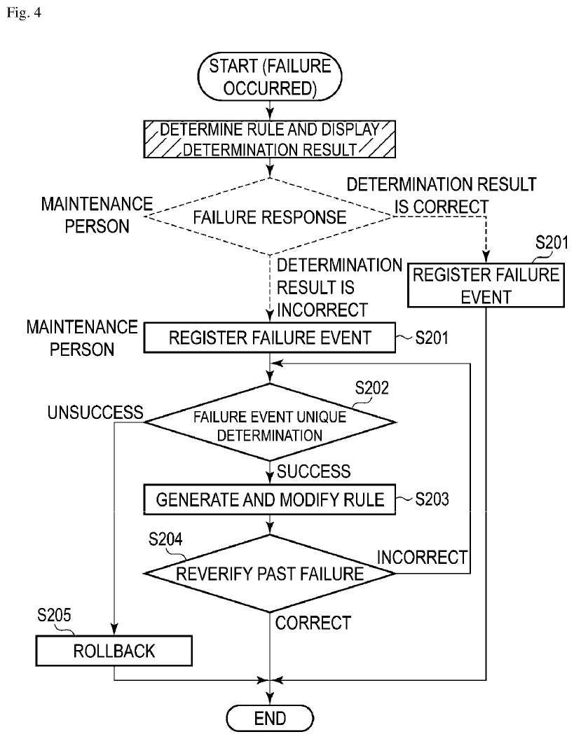

Further, one rule ID may be registered corresponding to a plurality of failure IDs so that a failure event registration is performed when the determination result is correct in a failure response (see FIG. 4).

Furthermore, one rule ID corresponds to one or more failure events, and thus may correspond to a large number of failure events.

For the present failure, the rule generation and modification unit 103 employs the unique pattern extracted by the unique determination unit 102 as the condition part, and employs the failure factor information registered by the maintenance person as the conclusion part. The rule generation and modification unit 103 revises the rule set by newly generating a rule using the condition part and the conclusion part, and associates a new rule ID with the failure ID to register the resultant in the failure case database 105.

On the other hand, if the unique pattern extracted by the unique determination unit 102 corresponding to one certain past failure registered in the failure case database 105 is different from the combination of failure events defined in the condition part of a rule registered corresponding to this failure ID, the rule generation and modification unit 103 determines that the rule needs to be modified.

The rule generation and modification unit 103 employs the extracted unique pattern as the condition part, modifies the existing rule by overwriting, and registers the result of this modification in the failure case database 105.

The past failure reverification unit 104 performs a redetermination by using the rule engine 330 on the basis of the information of the failure event group registered in the failure case database 105 for each failure ID.

The past failure reverification unit 104 collates failure factor information, which is a result of this determination, with the failure factor information registered in the failure case database 105. This information is registered by the maintenance person in the past.

The past failure reverification unit 104 determines that the new rule addition is successful when the result of this collating matches, that is, if the collation is OK, and further determines that the rule modification is also successful if the existing rule is modified by overwriting, and ends the processing.

On the other hand, if the collating result described above does not match, that is, if the collation is no good, the past failure reverification unit 104 causes the unique determination unit 102 to extract a different unique pattern again.

In the redetermination by the past failure reverification unit 104, the collation is matched in almost all cases, but the data may have undergone alteration or the like in rare cases, resulting in mismatch in the above collation. The past failure reverification unit 104 is provided for also responding to cases where the collation is mismatched as described above.

In the failure case database 105, (1) failure ID, (2) one or more failure events, (3) failure factor information, (4) combinations of failure events, (5) unique pattern among the combinations, and (6) rule ID are registered in association with each other.

In the failure case database 105, the above information is usually stored in association with a large number of failure IDs.

(Operation)

Next, operations of the pattern extraction and rule generation device 100 will be described. FIG. 4 is a flowchart illustrating an example of processing operations of the pattern extraction and rule generation device 100 illustrated in FIG. 3.

Once a failure has occurred, the rule engine 330 acquires one or more failure events (for example, device ID and alarm type) corresponding to the failure to perform a rule determination with reference to the network configuration information and the rule set, and displays determination results that indicate where the failure occurred and what caused the failure.

Thereafter, the maintenance person compares the result of the rule determination by the rule engine 330 with a failure response result that is a root cause to determine whether the determination result is correct.

When it is determined that the determination result is correct, this failure event is registered in the failure case database 105 in association with other information (see the “failure case database 105” described above) in accordance with an operation by the maintenance person on an operation device for the pattern extraction and rule generation device 100.

On the other hand, when it is determined that the determination result is incorrect, in accordance with an operation by the maintenance person on the operation device for the pattern extraction and rule generation device 100, the failure event registration unit 101 newly registers, in association with the other information, the failure factor information including the root cause and its location specified in a failure response by the maintenance person in the failure case database 105 in a manner corresponding to this failure event (step S201).

Following step S201, the unique determination unit 102 generates, as described with reference to FIG. 3, all combinations of failure events including one or more failure events associated with the failure ID of the present failure.

The unique determination unit 102 extracts one unique pattern for each failure ID from a combination of the failure events corresponding to the present failure and a combination of failure events corresponding to all past failures (past failure events are already registered in the failure case database 105) (step S202).

The extracted unique pattern is registered in the failure case database 105 in association with other information.

On the other hand, when this unique pattern cannot be extracted, the processing proceeds to step S205.

When the unique pattern is extracted in step S202, the rule generation and modification unit 103 employs the unique pattern in the present failure as a condition part, employs failure factor information input by the maintenance person as a conclusion part, newly generates a rule using the condition part and conclusion part, and registers the generated rule in the failure case database 105 (step S203).

Further, the rule generation and modification unit 103 also generates a rule ID corresponding to the generated rule and registers this rule ID in the failure case database 105. Furthermore, in a certain past failure registered in the failure case database 105, when a combination of failure events defined in the condition part of a rule registered for the failure is different from the unique pattern extracted in step S202, the rule generation and modification unit 103 modifies the rule for the failure and registers the modified rule in the failure case database 105 (step S203).

The past failure reverification unit 104 uses the rule engine 330 to redetermine whether the determination results are correctly determined in all the failures registered in the failure case database 105, and verifies whether determination accuracy has not decreased due to update of the rule set (step S204).

When the determination result is incorrect in any of the past failures, the processing returns to step S202, and the unique determination unit 102 extracts a combination of the other failure events.

Further, when all rules generated from the unique pattern in step S204 have resulted in mismatch in the collation in the past failure reverification unit 104, the processing proceeds to step S205. On the other hand, when all the failures registered in the failure case database 105 are verified in the past failure reverification unit 104 and resulted in match in the collation and the determination result is correct, it is considered to be the new rule addition or rule modification is successful, and the processing ends.

In step S205, when the failure event characterizing the present failure cannot be extracted, the unique determination unit 102 presents an indication that the failure cannot be made as a rule and performs rollback the data.

In other words, in this case, the unique determination unit 102 cancels the registration of the failure event corresponding to the failure ID of the corresponding present failure and the failure factor information registered by the maintenance person (step S205).

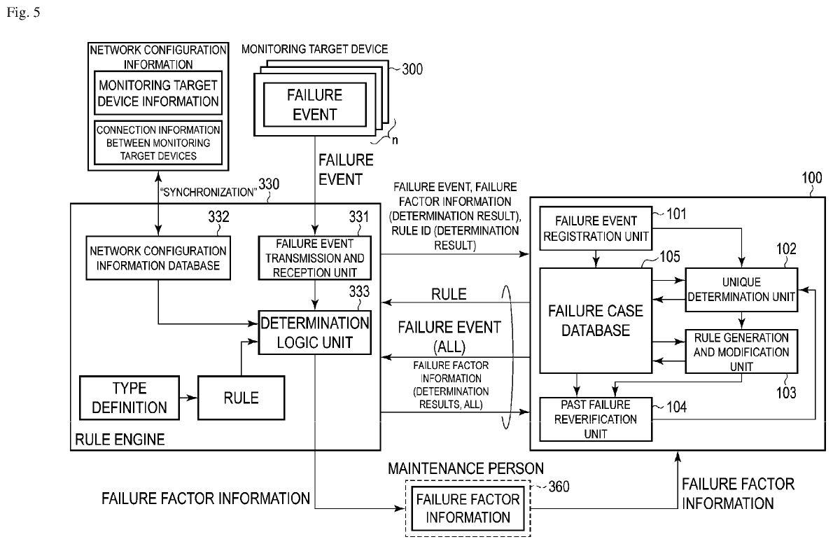

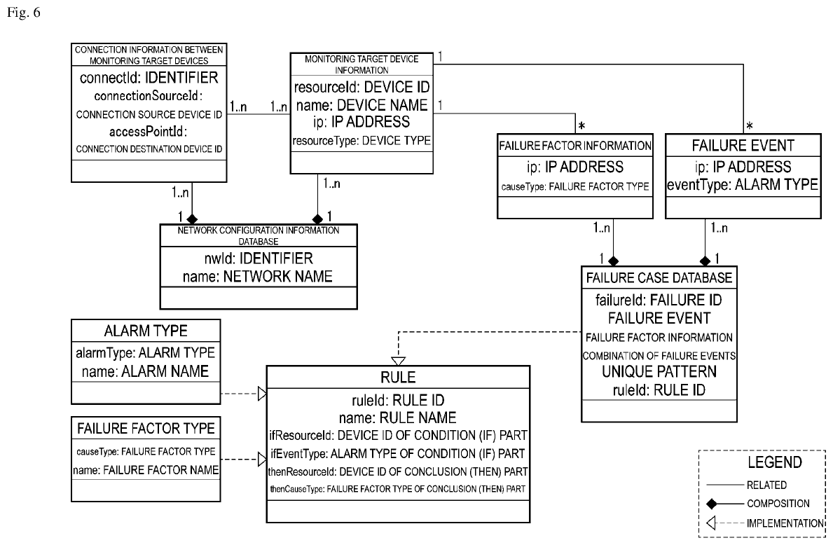

Next, a processing flow of the pattern extraction and rule generation device 100, monitoring target devices 300, the rule engine 330, and the maintenance person 360 according to the present embodiment will be described with reference to FIGS. 5, 6, 7A, 7B, and 7C. Note that “*” in FIG. 6 indicates the number of instances and means a numerical value equal to or greater than zero.

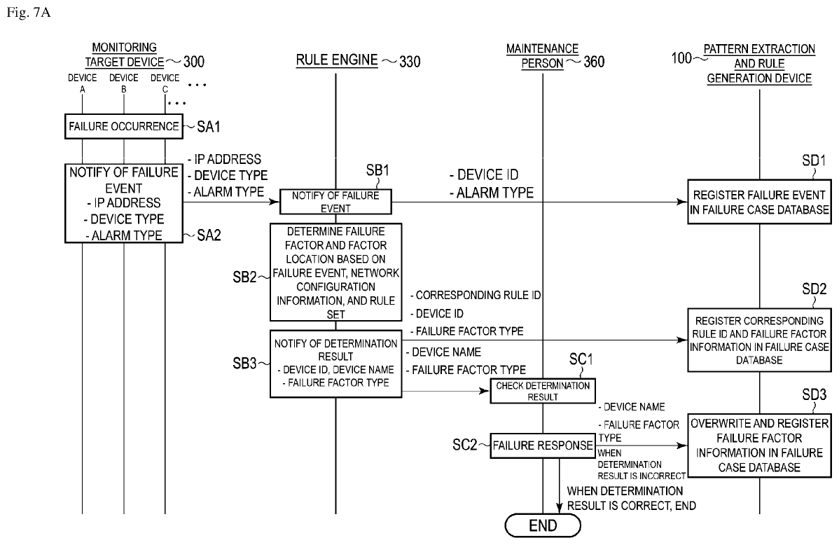

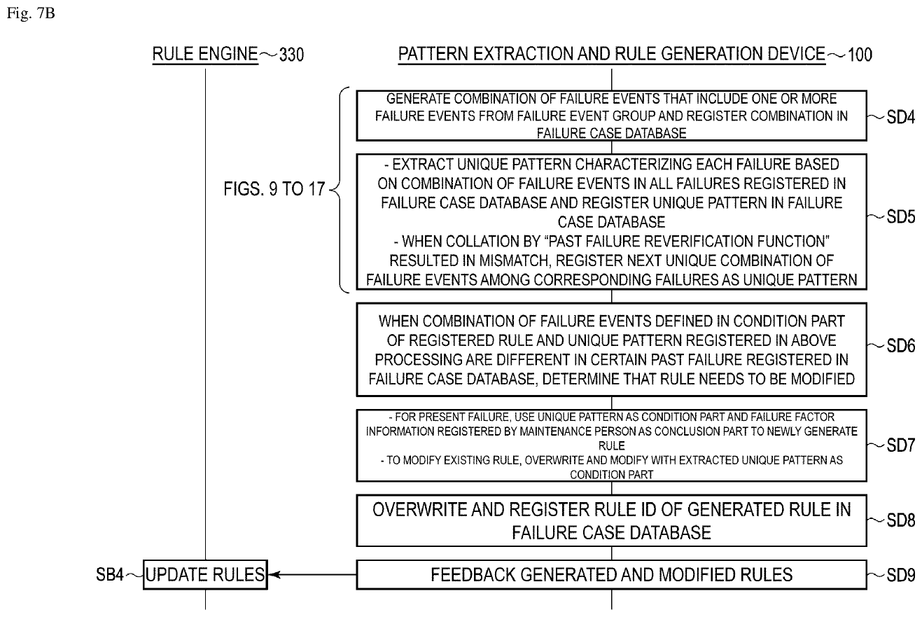

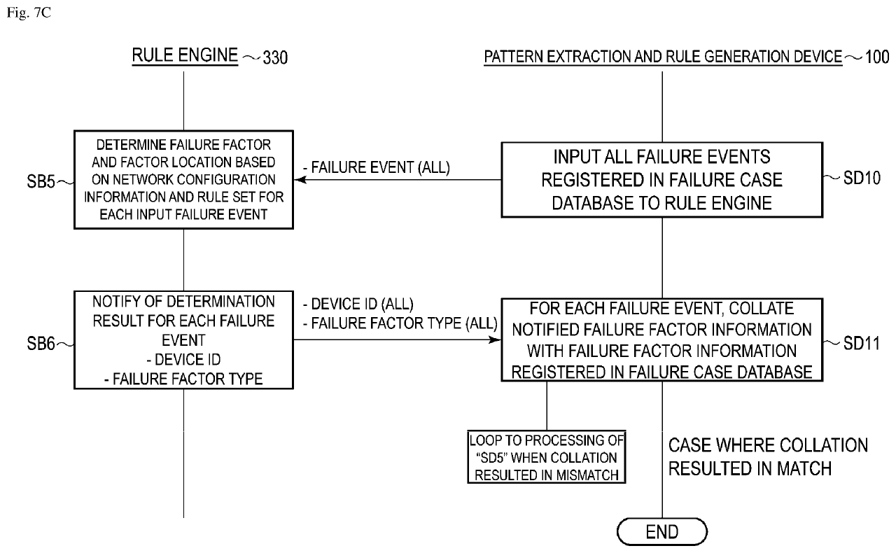

First, it is assumed that a failure occurs in one or more devices among the n monitoring target devices 300 (step SA1 in FIG. 7A).

Thereafter, the monitoring target device 300 inputs the failure event into the rule engine 330 (step SA2).

The failure event here includes, for example, (1) IP address, (2) device type, and (3) alarm type. Note that the alarm type is one of event types, and is used as a subordinate concept thereof.

The rule engine 330 notifies the pattern extraction and rule generation device 100 of the failure event (device ID, alarm type) (step SB1).

At this stage, the rule engine 330 notifies the pattern extraction and rule generation device 100 of the device ID and the alarm type, for example. The failure event registration unit 101 registers this failure event in the failure case database 105 (step SD1).

Further, in the rule engine 330, the network configuration information database 332 acquires network configuration information from the outside and synchronizes it with external information in advance.

The network configuration information includes monitoring target device information and connection information between monitoring target devices.

As illustrated in FIG. 6, the monitoring target device information includes, for example, (1) device ID, (2) device name, (3) IP address, and (4) device type of the monitoring target device.

As illustrated in FIG. 6, the connection information between monitoring target devices includes, for example, (1) connection source device ID, (2) connection destination device ID, and (3) identifier of set of these (1) and (2).

In the example illustrated in FIGS. 5 and 6, the monitoring target device information is provided by the amount of n devices, which is the number of monitoring target devices. Note that the connection information between monitoring target devices is not limited to the amount of n devices.

Moreover, in the rule engine 330, the failure event transmission and reception unit 331 acquires the failure event from the external monitoring target device 300.

Further, in the rule engine 330, a set of IF-THEN rules associating the failure event group with the failure factor information is stored, for example, in the data memory 62.

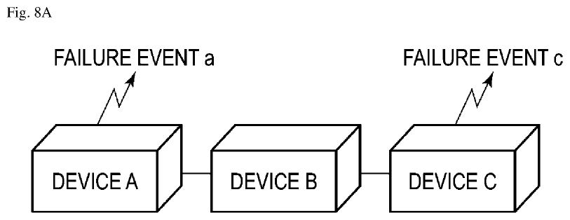

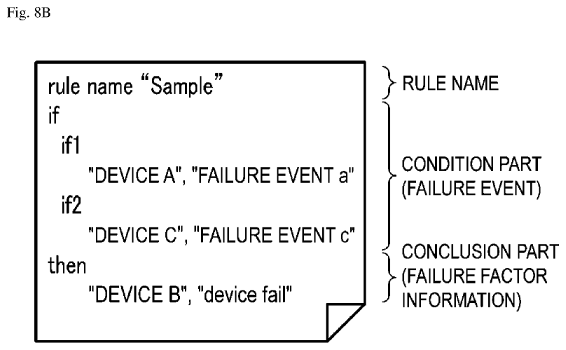

The IF-THEN rules are constituted by an IF part representing a premise or a condition and a THEN part representing a conclusion or action if this IF part is true (see more detail in the description of FIGS. 8A and 8B).

The rule engine 330 further has a determination logic unit 333.

The determination logic unit 333 receives each of the network configuration information (in the network configuration information database 332), the failure event, and the rule set, and obtains, based on them, a determination result indicating each of where the failure has occurred (failure location) and what has caused the failure (failure factor) (step SB2).

Thereafter, the determination logic unit 333 sends the determination result, for example, (1) corresponding rule ID, (2) device ID and/or device name, and (3) failure factor type to the pattern extraction and rule generation device 100 (to SD2), and sends the determination result (for example, device name and failure factor type) to the maintenance person 360 (to SC1) (step SB3).

In the pattern extraction and rule generation device 100, the failure event registration unit 101 registers the determination result from the determination logic unit 333, for example, (1) corresponding rule ID, (2) device ID and/or device name, and (3) failure factor type in the failure case database 105 (step SD2).

The maintenance person 360 receives the determination result from the rule engine 330 and checks the contents (step SC1).

Thereafter, the maintenance person 360 compares the determination result by the rule engine 330 with a failure response result that is a root cause, and determines whether the determination result is correct (step SC2).

When it is determined in step SC2 that the determination result is correct, the maintenance person 360 ends without doing anything.

On the other hand, when it is determined in step SC2 that the determination result is incorrect, the failure event registration unit 101 registers the failure factor information that is information including the root cause (device name) and its location specified in a failure response by the maintenance person 360 in the failure case database 105 in a manner corresponding to this failure event.

The pattern extraction and rule generation device 100 registers the identified failure factor information in the failure case database 105 in a manner corresponding to this failure event (step SD3). Thereafter, the processing in the pattern extraction and rule generation device 100 continues.

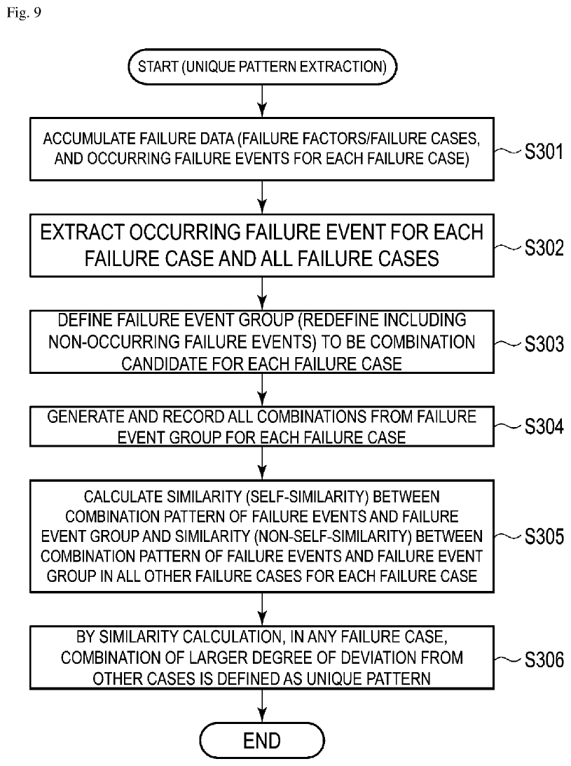

The unique determination unit 102 generates all combinations of failure events including one or more failure events from the failure event group of the present failure and registers the result of this generation in the failure case database 105 (step SD4 in FIG. 7B). Details of step SD3 and step SD4 will be described with reference to FIGS. 9 to 17, which will be described below.

The unique determination unit 102 extracts a unique pattern characterizing each failure from combinations of failure events in all failures registered in the failure case database 105 and registers the results of this extraction in the failure case database 105.

Further, if the past failure reverification unit 104 reverifies the determination result for each failure and resulted in mismatch in the collation, the unique determination unit 102 registers the next unique combination of failure events in the corresponding failure as a unique pattern in the failure case database 105 (Step SD5).

The rule generation and modification unit 103 compares, in certain past failures registered in the failure case database 105, the combination of failure events defined in the condition part of the registered rule with a unique pattern registered in the processing up to the present. When the compared combination of failure events and unique pattern are different, the rule generation and modification unit 103 determines that the rule needs to be modified (steps SD6).

For the present failure, the rule generation and modification unit 103 employs the unique pattern as a condition part, employs the failure factor information registered by the maintenance person 360 as a conclusion part, and newly generates a rule using the condition part and the conclusion part. As modification of the existing rules, the rule generation and modification unit 103 modifies the existing rules by overwriting with the extracted unique pattern as the condition part (step SD7).

Thereafter, the rule generation and modification unit 103 overwrites and registers the rule ID of the generated rule in the failure case database 105 (steps SD8).

The rule generation and modification unit 103 feeds back the generated and modified rules to the rule engine 330 (steps SD9).

The rule engine 330 incorporates the generated and modified rules to update the rule set (step SB4).

The pattern extraction and rule generation device 100 passes all failure events registered in the failure case database 105 to the rule engine 330 in units of failure IDs (step SD10). The rule engine 330 receives all of the failure events, and determines each of the failure factor and the failure factor location on the basis of the failure event group input per failure ID, and the network configuration information and the rule set (step SB5).

Then, the rule engine 330 notifies the pattern extraction and rule generation device 100 of the determination results for each failure ID, for example, the device ID and the failure factor type (step SB6).

The pattern extraction and rule generation device 100 collates, for each failure ID, the determination results notified from the rule engine 330 to the past failure reverification unit 104, for example, the device ID and the failure factor type, with the failure factor information registered in the failure case database 105 (step SD11).

When there is a failure ID whose collation results in mismatch, the processing returns to step SD5, and the unique determination unit 102 extracts the unique pattern and performs rule generation or modification.

On the other hand, if the collation results in match for all of the failure events, the processing by the unique determination unit 102 ends.

Here, the IF-THEN rule used in the rule engine 330 will be briefly described with reference to FIGS. 8A and 8B.

The IF-THEN rule describes knowledge of inference such as a conclusion derived from a certain fact and knowledge of behavior that occurs when certain conditions are met.

In general, the IF-THEN rule is described in the form of “α→β”, “if α then β”, and is composed of an IF part representing a premise or condition and a THEN part representing a conclusion or action executed if the IF part is true.

The examples illustrated in FIGS. 8A and 8B are rules for determining a failure factor location, and indicate that the device b is “device fail” when a failure event a occurs in a device A and a failure event c occurs in a device C.

Next, a processing operation by the unique determination unit will be described in detail. FIG. 9 is a flowchart illustrating an example of a processing operation performed by the unique determination unit.

(Registration in Failure Case Database)

First, prior to processing by the unique determination unit 102, the failure event registration unit 101 registers the failure factors, failure cases, and occurring failure events for each failure case in the failure case database 105 (S301).

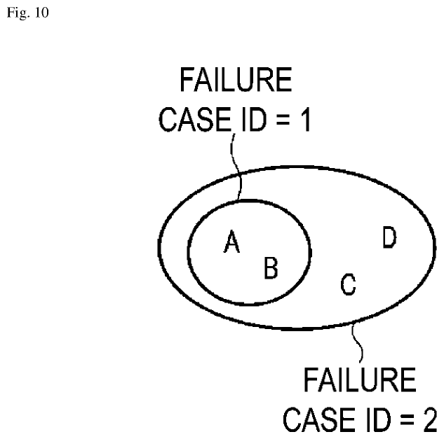

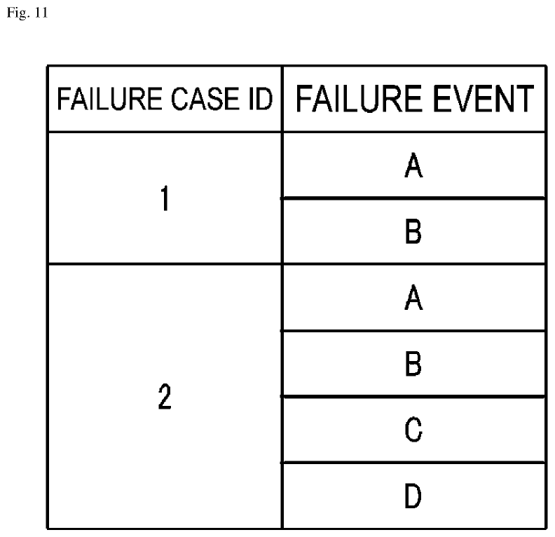

FIG. 10 is a diagram illustrating an example of a relationship between a failure case and a failure event corresponding to the failure case. FIG. 11 is a diagram illustrating, in tabular form, an example of a relationship between a failure case and a failure event corresponding to the failure case.

In the example illustrated in FIGS. 10 and 11, failure events A, B correspond to a failure case with a failure case ID=1 (sometimes referred to as failure case (1)). In addition, failure events A, B, C, and D correspond to a failure case with a failure case ID=2 (sometimes referred to as failure case (2)). These correspondences are registered in the failure case database 105.

(Extraction of Failure Event Group)

Next, the unique determination unit 102 extracts an occurring event group for each failure case and occurring failure events in all failure cases from a failure factor, a failure case, and an occurring failure event for each failure case that are registered in the failure case database 105 (S302).

An occurring failure event group X₁ for the failure case related to the failure case ID=1, an occurring failure event group X₂ for the failure case related to the failure case ID=2, and all failure event groups Xₐₗₗ, which are illustrated in FIGS. 10 and 11, are represented by (1), (2), and (3) below.

X₁=(A,B) (1)

X₂=(A,B,C,D) (2)

Xₐₗₗ=(A,B,C,D) (3)

(Definition of Failure Event Group)

Next, the unique determination unit 102 defines a failure event group that is a combination candidate in each failure case by including a non-occurring failure event in addition to the occurring failure event described above (S303). A combination candidate is a combination of elements of a rule condition part.

Here, the failure case in which a NOT (negative) condition is included in the failure event that is a combination candidate is only a failure case that is a subset illustrated in FIG. 10.

A candidate failure event group X₁ for the failure case related to the failure case ID=1 illustrated in FIGS. 10 and 11 is represented by (4) below. Further, a candidate failure event group X₂ for the failure case related to the failure case ID=2 is represented by (5) below.

[Math. 1]

X₁=(A,B,C̅,D̅) (4)

X₂=(A,B,C,D) (5)

In failure case (1), among the all failure event groups (A, B, C, D), event groups (C, D) that have not occurred are extracted, and with these event groups as failure events which have to be prevented from occurring and as negative conditions, the candidate failure event group X₁ is defined as in (4) above.

(Generation of all Combinations)

Next, from the candidate failure event group defined in S303, the unique determination unit 102 extracts all combinations including one or more occurring failure events, for each failure case,

R_{i,k}_{ᵢ} [Math. 2]

and records them in the failure case database 105 (S304). The meanings of i and kᵢ in all the combinations above will be described below.

i: failure case ID
Kᵢ: combination ID in case i
The combination ID is an ID given to each combination of failure event groups.

When there is an upper limit on the number of conditions in the IF part, that is, the number of failure events included in a single combination, a combination pattern satisfying the number of conditions that is this upper limit is generated. Here, it is assumed that the number of conditions is 2. By providing the upper limit on the number of conditions of the IF part in this way, the amount of calculation when applying the rules can be reduced compared to when there is no upper limit.

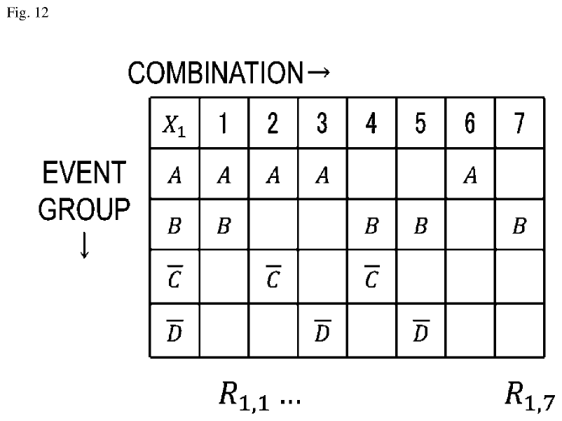

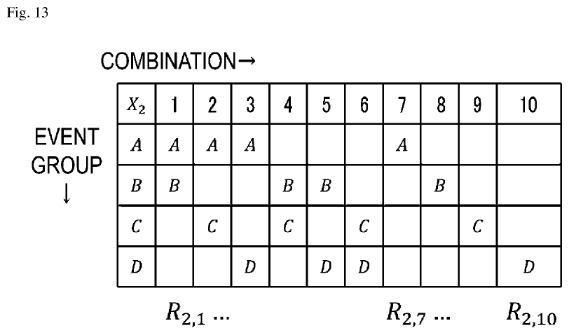

FIGS. 12 and 13 are diagrams illustrating, in tabular form, examples of combinations of failure events extracted from the candidate failure event group. FIG. 12 illustrates combinations of failure events for the failure case (1) above, and FIG. 13 illustrates combinations of failure events for the failure case (2) above.

In this example, in the combinations of failure events, the number of conditions of the failure events is two, and each of the combinations illustrated in FIG. 12 always include the occurring failure event (A or B) in the failure case (1) above. Thus, in the example illustrated in FIG. 12, there are seven combinations. Furthermore, each of the combination illustrated in FIG. 13 always include the occurring failure events (A, B, C, or D) in the failure case (2) above. Thus, in the example illustrated in FIG. 13, there are 10 combinations.

In the present embodiment, for each failure case, it is derived which combination is the most unique, that is, can generate a good rule.

The definition of “the most unique (=good rule)” described above is that:

(1) matches (resembles) the failure case; and
(2) does not match (does not resemble) other failure cases.

The above (1) indicates that there is a large similarity between a pattern of a certain combination and a failure event group in the failure case.

Further, the above (2) indicates that there is a small similarity between a pattern of a certain combination and a failure event groups in other failure cases.

(Calculation of Similarity)

Next, the unique determination unit 102 calculates, for each failure case, a self-similarity that is a similarity between a combination pattern of failure events and a failure event group in the failure case. Moreover, the unique determination unit 102 calculates, for each failure case, a non-self-similarity that is a similarity between a combination pattern of failure events and a failure event group in all other failure cases other than the failure case (S305).

For example, the unique determination unit 102 can calculate the self-similarity using (5) below. Furthermore, the unique determination unit 102 can calculate the non-self-similarity using (6) below. The definitions in (5) and (6) below are described in (7) and (8) below. The n in this ((7) is the number of all failure events included in the failure case. The value that j in this (8) may take is 1 to n.

$$\begin{matrix}[ Math . 3 ] & \\ S ( {\vec{R}}_{i , {k}_{i}} , {\vec{X}}_{i} ) = \frac{{\vec{R}}_{i , {k}_{i}} \cdot {\vec{X}}_{i}}{\vert {\vec{R}}_{i , {k}_{i}} \vert \vert {\vec{X}}_{i} \vert} & ( 5 )\end{matrix}$$

$$S ( {\vec{R}}_{i , {k}_{i}} , {\vec{X}}_{j} ) = \frac{{\vec{R}}_{i , {k}_{i}} \cdot {\vec{X}}_{j}}{\vert {\vec{R}}_{i , {k}_{i}} \vert \vert {\vec{X}}_{j} \vert} ( j \neq i ) \qquad ( 6 )$$

$${\vec{R}}_{i , {k}_{i}} = ( {x}_{1} , {x}_{2} , {x}_{3} , … , {x}_{n} ) \qquad ( 7 )$$

$${x}_{j} = \{ \begin{matrix}1 , & WHEN Aj - TH ALARM OCCURS \\ 0 , & WHEN Aj - TH ALARM DOES NOT OCCURS \\ - 1 , & WHEN Aj - TH ALARM SHOULD NOT OCCURS\end{matrix} \qquad ( 8 )$$

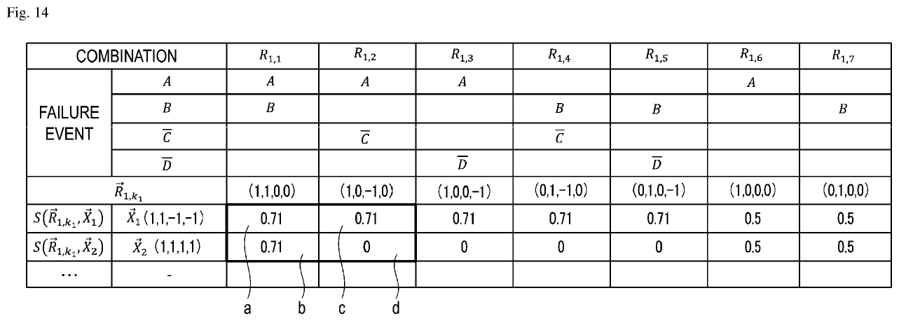

FIG. 14 is a diagram illustrating, in tabular form, an example of a calculation result of similarity. In FIG. 14, a calculation result of the self-similarity and the non-self-similarity in the above-described failure case (1) is illustrated.

A calculation equation for the self-similarity (a in FIG. 14) in the first combination in the failure case (1) is described in (9) below, and a calculation equation for the non-self-similarity in the same combination (b in FIG. 14) is described in (10) below.

Further, a calculation equation for self-similarity (c in FIG. 14) in the second combination in the failure case (1) is described in (11) below, and a calculation equation for the non-self-similarity in the same combination (d in FIG. 14) is described in (12) below.

$$\begin{matrix}[ Math . 4 ] & \\ S ( {\vec{R}}_{1 , 1} , {\vec{X}}_{1} ) = \frac{{\vec{R}}_{1 , 1} \cdot {\vec{X}}_{1}}{\vert {\vec{R}}_{1 , 1} \vert \vert {\vec{X}}_{1} \vert} = \frac{1 + 1 + 0 + 0}{\sqrt{1 + 1} \cdot \sqrt{1 + 1 + 1 + 1}} = \frac{1}{\sqrt{2}} & ( 9 )\end{matrix}$$

$$S ( {\vec{R}}_{1 , 2} , {\vec{X}}_{1} ) = \frac{{\vec{R}}_{1 , 2} \cdot {\vec{X}}_{1}}{\vert {\vec{R}}_{1 , 2} \vert \vert {\vec{X}}_{1} \vert} = \frac{1 + 0 + 1 + 0}{\sqrt{1 + 1} \cdot \sqrt{1 + 1 + 1 + 1}} = \frac{1}{\sqrt{2}} \qquad ( 10 )$$

$$S ( {\vec{R}}_{1 , 1} , {\vec{X}}_{2} ) = \frac{{\vec{R}}_{1 , 1} \cdot {\vec{X}}_{2}}{\vert {\vec{R}}_{1 , 1} \vert \vert {\vec{X}}_{2} \vert} = \frac{1 + 0 + 0 + 0}{\sqrt{1 + 1} \cdot \sqrt{1 + 1 + 1 + 1}} = \frac{1}{\sqrt{2}} \qquad ( 11 )$$

$$S ( {\vec{R}}_{1 , 2} , {\vec{X}}_{2} ) = \frac{{\vec{R}}_{1 , 2} \cdot {\vec{X}}_{2}}{\vert {\vec{R}}_{1 , 2} \vert \vert {\vec{X}}_{2} \vert} = \frac{1 + 0 - 1 + 0}{\sqrt{1 + 1} \cdot \sqrt{1 + 1 + 1 + 1}} = 0 \qquad ( 12 )$$

(Extraction of Unique Pattern)

Next, as a result of the similarity calculation described above, the unique determination unit 102 extracts, in any failure case, a combination having a large degree of deviation from other failure cases as a unique pattern (S306).

Here, the unique determination unit 102 calculates the self-similarity and the maximum non-self-similarity for each combination pattern, and identifies a combination in which the difference between the respective similarities is maximum.

The unique determination unit 102 defines a degree of deviation that is uniqueness for each of the failure cases i, and determines a pattern of a combination in which the degree of deviation becomes the maximum.

The degree of deviation in the above failure case (1) is calculated by (13) below.

$$\begin{matrix}[ Math . 5 ] & \\ DEGREE OF DEVIATION ( UNIQUESNESS ) = S ( {\vec{R}}_{1 , {k}_{1}} , {\vec{X}}_{1} ) - {max}_{j \neq 1} S ( {\vec{R}}_{1 , {k}_{1}} , {\vec{X}}_{j} ) & ( 13 )\end{matrix}$$

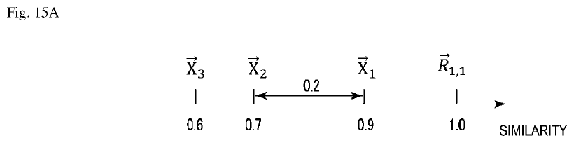

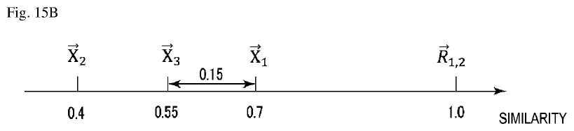

FIGS. 15A and 15B are diagrams illustrating extraction of a unique pattern based on the degree of deviation.

FIG. 15A illustrates an example of a similarity between a pattern of a first combination of failure events in a certain failure case and various failure event groups is illustrated, and FIG. 15B illustrates an example of a similarity between a pattern of a second combination of failure events in the same failure case and various failure event groups is illustrated. The numerical values in this example are not particularly related to the values presented in FIG. 14 and the like.

Here, there are two combinations of failure patterns, a first combination and a second combination, and in the example illustrated in FIG. 15A, a difference between the self-similarity and the maximum non-self-similarity is 0.2, and in the example illustrated in FIG. 15B, the difference between the self-similarity and the maximum non-self-similarity is 0.15.

Thus, the example illustrated in FIG. 15A satisfies the condition that the degree of deviation, which is the difference between the self-similarity and the maximum non-self-similarity, is maximum in each combination, and thus the first combination described above satisfies the conditions of extraction of the unique pattern.

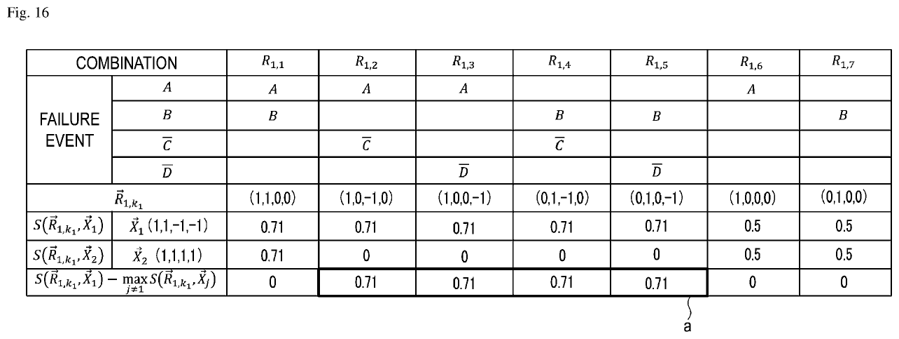

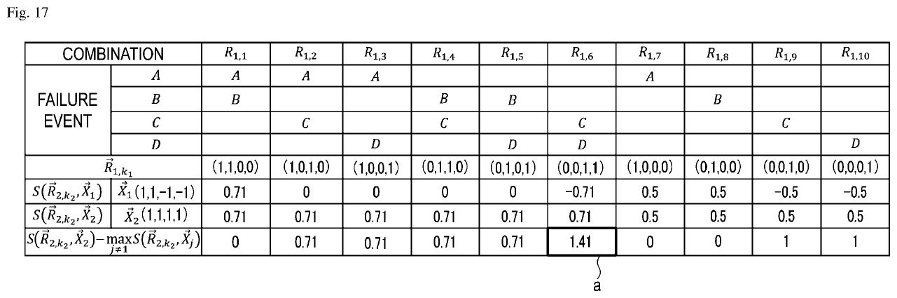

FIG. 16 and FIG. 17 are diagrams illustrating, in tabular form, an example of calculation results of the degree of deviation. In FIG. 16, a calculation result of the degree of deviation in the aforementioned failure case (1) is illustrated. Furthermore, in FIG. 17, the calculation result of the degree of deviation in the case of the failure case (2) above is illustrated.

In the example illustrated in FIG. 16, in four combinations among seven combinations of the failure patterns in the failure case (1) above, the calculation result of the degree of deviation is 0.71 (a in FIG. 16) that is the maximum among all the combinations, and thus any of these combinations can be extracted as a unique pattern.

Further, in the example illustrated in FIG. 17, in one of 10 combinations of the failure patterns in the failure case (2) above, the calculation result of the degree of deviation is 1.41 (a in FIG. 17) that is the maximum among all the combinations, and thus these combinations are extracted as unique patterns.

Consequently, a unique pattern in the failure case (1), that is, a unique combination of failure events is indicated by (14) below.

[Math. 6]

A,C̅ or A,D̅ or B,C or B,D̅) (14)

Furthermore, the unique pattern in the failure case (2) above is represented by (14) below.

C,D (15)

Here, a supplementary description of setting of negative conditions indicated by the candidate failure event group will be described.

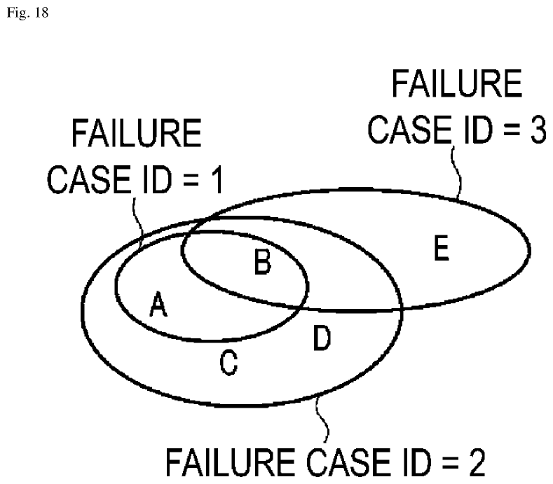

FIG. 18 is a diagram illustrating an example of a relationship between a failure case and a failure event corresponding to the failure case.

In the example illustrated in FIG. 18, failure events A and B correspond to a failure case with a failure case ID=1. Failure events A, B, C, and D correspond to failure cases with a failure case ID=2. Moreover, failure events B and E correspond to failure cases with a failure case ID=3. These correspondences are registered in the failure case database 105.

Thus, an occurring failure event group X₁ for the failure case related to the failure case ID=1, an occurring failure event group X₂ for the failure case related to the failure case ID=2, an occurring failure event group X₃ for the failure case related to the failure case ID=3, and all failure event groups Xₐₗₗ, which are illustrated in FIG. 18, are represented by following (16), (17), (18), and (19), respectively.

X₁=(A,B) (16)

X₂=(A,B,C,D) (17)

X₃=(B,E) (18)

Xₐₗₗ=(A,B,C,D,E) (19)

Although it has been described that the negative condition is set for a candidate failure event based on an occurring failure event group in each failure case, assuming that the target for which this negative condition is set is only a failure case (child case) corresponding to a child with which a failure event group is in an inclusion relationship among a plurality of failure cases, an event that has not occurred in a child case among failure events in a failure case (parent case) corresponding to the parent of the child case in the parent-child relationship of a subset may be set to the negative condition in this child case.

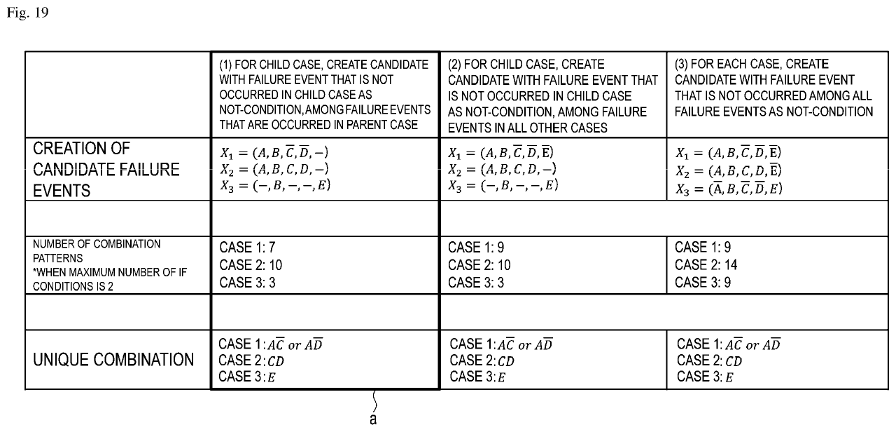

FIG. 19 is a diagram illustrating, in tabular form, an example of the creation of candidate failure events, the number of combination patterns, and the unique combination to be extracted. In the example illustrated in FIG. 19,

(1) for the child case, example in which a candidate failure event is created with a failure event that has not occurred in a child case as the negative condition, among failure events occurring in the parent case,
(2) for the child case, example in which a candidate failure event is created with a failure event that has not occurred in a child case as the negative condition of this child case, among failure events in all other cases, and
(3) in failure cases, example in which a candidate failure event is created with an event that has not occurred among all failure events as the negative condition of each failure case are described.

In the example illustrated in FIG. 19, the “(1) for the child case, example in which a candidate failure event is created with a failure event that has not occurred in a child case as the negative condition, among failure events occurring in the parent case” surrounded by a in FIG. 19 has the smallest number of combination patterns in each of the failure cases, and thus the processing speed involved in extraction of the unique pattern can be improved.

As described above, since the pattern extraction and rule generation device according to one embodiment of the present disclosure automatically creates a rule with a non-occurring failure event that does not occur due to a failure as a negative condition, an appropriate estimation of a failure is possible, and a learning time involved in rule generation can be reduced. Further, the load related to isolating related to failure events by a maintenance person is alleviated.

Further, a scheme described in each of the embodiments is stored in a recording medium such as a magnetic disk (a Floppy (registered trademark) disk, a hard disk, or the like), an optical disc (a CD-ROM, a DVD, an MO, or the like), a semiconductor memory (a ROM, a RAM, a flash memory, or the like) or transferred by a communication medium for distribution, as a program (a software unit) that can be executed by a calculator (a computer). The program stored in the medium also includes a setting program incorporating a software unit (including not only an execution program but also a table or data structure), which will be executed in a computing machine, into the computing machine. A calculator actualizing the present device executes the above-described processing by loading the program recorded on the recording medium or constructing a software unit using the setting program in some cases, and controlling an operation using the software unit. Note that the recording medium referred to herein is not limited to a recording medium for distribution but includes a storage medium such as a magnetic disk or a semiconductor memory provided in the calculator or a device connected thereto via a network.

It is to be noted that the present disclosure is not limited to the aforementioned embodiments and can be variously modified in the implementation stage without departing from the gist of the present disclosure. An appropriate combination of the embodiments can also be implemented, in which a combination of their effects can be obtained. Further, the above embodiments include various disclosures, which can be designed by combining constituent elements selected from a plurality of constituent elements disclosed here. For example, a configuration in which some constituent elements are removed from all the constituent elements shown in the embodiments can be designed as an disclosure if the problems can be solved and the effects can be achieved.

### REFERENCE SIGNS LIST

100 . . . Rule generation device
101 . . . Failure event registration unit
102 . . . Unique determination unit
103 . . . Modification unit
104 . . . Past failure reverification unit
105 . . . Failure case database
300 . . . Monitoring target device
330 . . . Rule Engine
331 . . . Failure event transmission and reception unit
332 . . . Network configuration information database
333 . . . Determination logic unit

1. A pattern extraction and rule generation device comprising:
a database where failure factor information including a failure factor location and a failure factor, an occurring failure event that is a failure event occurring due to a failure and a non-occurring failure event that is a failure event not occurring due to the failure, and a rule ID associated with a rule including condition parts and conclusion parts are registered, by a failure type, in association with each other;
a processor; and
a storage medium having computer program instructions stored thereon, when executed by the processor, perform to:
generate, by the failure type, all of one or more possible combinations of the occurring failure event and the non-occurring failure event included in a failure event group including the occurring failure event and the non-occurring failure event associated with a new failure that is a newly occurring failure, and
extract, from combinations of failure events of a new failure and combinations of failure events of one or more past failures that are failures occurred in the past, by the failure type, a unique pattern that is determined to be a combination most different from a failure event in other failure cases every time the new failure occurs; and
generate or modify, when the non-occurring failure event is selected for the one or more possible combinations according to the unique pattern corresponding to each failure, the rule with the failure event as a negative condition.

2. The pattern extraction and rule generation device according to claim 1, wherein the computer program instructions further perform to
extracts, every time the new failure occurs, a unique pattern that is determined to be a combination most different from a failure event in other failure cases among combinations of failure events satisfying an upper limit of the number of condition parts included in the rule.

3. The pattern extraction and rule generation device according to claim 1, wherein the computer program instructions further perform to
calculates, for a predetermined type of a failure, a self-similarity that is a similarity between the one or more possible combinations generated and a failure event group related to the predetermined type related to the one or more possible combinations,
calculates a non-self-similarity that is a similarity between the one or more possible combinations generated and a failure event group related to a type different from the predetermined type, and
determines, as the unique pattern, among the one or more possible combinations generated for the predetermined type of the failure, a combination having a largest degree of deviation that is a difference between the self-similarity calculated and the non-self-similarity calculated, and extracts the unique pattern by the failure type every time the new failure occurs.

4. A pattern extraction and rule generation method performed by a pattern extraction and rule generation device including a database where failure factor information including a failure factor location and a failure factor, an occurring failure event that is a failure event occurring due to a failure and a non-occurring failure event that is a failure event not occurring due to the failure, and a rule ID associated with a rule including condition parts and conclusion parts are registered, by a failure type, in association with each other, the method comprising:
generating, by the failure type, all of one or more possible combinations of the occurring failure event and the non-occurring failure event included in a failure event group including the occurring failure event and the non-occurring failure event associated with a new failure that is a newly occurring failure, and extracting, from combinations of failure events of a new failure and combinations of failure events of one or more past failures that are failures occurred in the past, by the failure type, a unique pattern that is determined to be a combination most different from a failure event in other failure cases every time the new failure occurs; and
generating or modifying, when the non-occurring failure event is selected for the one or more possible combinations according to the unique pattern corresponding to each failure, the rule with the failure event as a negative condition.

5. The pattern extraction and rule generation method according to claim 4, wherein
the extracting includes extracting, every time the new failure occurs, a unique pattern that is determined to be a combination most different from a failure event in other failure cases among combinations of failure events satisfying an upper limit of the number of condition parts included in the rule.

6. The pattern extraction and rule generation method according to claim 4, wherein
the extracting includes calculating, for a predetermined type of a failure, a self-similarity that is a similarity between the one or more possible combinations generated and a failure event group related to the predetermined type related to the combinations,
calculating a non-self-similarity that is a similarity between the one or more possible combinations generated and a failure event group related to a type different from the predetermined type, and
determining, as the unique pattern, among the one or more possible combinations generated for the predetermined type of the failure, a combination having a largest degree of deviation that is a difference between the self-similarity calculated and the non-self-similarity calculated, and extracting the unique pattern by the failure type every time the new failure occurs.

7. A non-transitory computer-readable medium having computer-executable instructions that, upon execution of the instructions by a processor of a computer, cause the computer to function as the pattern extraction and rule generation device according to claim 1.
